(19) United States
(12) Patent Application Publication
(10) Pub. No.: US 2009/0025699 A1
(43) Pub. Date: Jan. 29, 2009

(54) DEVICE FOR THROWING AN OBJECT

(75) Inventors: Sumith Jack Mongkolkasetarin, Aliso Viejo, CA (US); Ben Kingsbury, Davis, CA (US)

Correspondence Address: LOZA & LOZA LLP, 305 N. SECOND AVENUE, #127, UPLAND, CA, 91786-6064, US

(73) Assignee: 3Zilla, LLC, Aliso Viejo, CA (US)

(21) Appl. No.: 11/828,966

(22) Filed: Jul. 26, 2007

(51) Int. Cl. F41B 15/00

(52) U.S. Cl. 124/26

(57) ABSTRACT

A device for throwing an object is provide which includes a body having a first and second end, where the second end is connected to a pivot mechanism; and a swingable arm rotatable between a first position and a second position. The swingable arm has a first end connected to the pivot mechanism and a second end connected to an object holder. The pivot mechanism includes a pivot housing including at least one outwardly extending protrusion to stop rotation; and a base unit rotatably engaged with the pivot housing and capable of rotating the swingable arm relative to the base unit.

### BACKGROUND

### Field of Invention

This invention relates generally to the field of toys and more particularly to a device for throwing an object.

### Background of the Invention

Pet owners often exercise their dogs by playing fetch. An object, such as a ball, is thrown a moderate distance away from the animal, and the animal grabs and retrieves the object. Typically, the object is thrown with the arm of the owner, which can cause the arm to become weaker with every throw. As the owner's arm becomes weaker, the owner has difficulty repeatedly throwing the object any substantial distance for the dog to retrieve. Additionally, the ball or object used to play fetch often becomes covered in pet saliva after a few tosses and returns, which can be both uncomfortable for the owner and is not hygienic.

What is needed is device for throwing an object that is easy to throw by letting an owner throw the object as far as possible with as minimal physical effort as possible.

### SUMMARY OF THE INVENTION

This brief summary has been provided so that the nature of the invention may be understood quickly. A more complete understanding of the invention can be obtained by reference to the following detained description of the embodiments thereof in connection with the attached drawings.

In one aspect of the present invention, a device for throwing an object is provided which includes a body having a first and second end, where the second end is connected to a pivot mechanism; and a swingable arm rotatable between a first position and a second position. The swingable arm has a first end connected to the pivot mechanism and a second end connected to an object holder. The pivot mechanism includes a pivot housing including at least one outwardly extending protrusion to stop rotation; and a base unit rotatably engaged with the pivot housing and capable of rotating the swingable arm relative to the base unit.

### BRIEF DESCRIPTION OF THE DRAWINGS

The foregoing features and other features of the present invention will now be described with reference to the drawings of embodiments. The illustrated embodiments are intended to illustrate, but not to limit the invention. The drawings include the following:

FIG. 1 is a perspective view of a device for throwing an object, the device in an extended position in accordance with one embodiment of the present invention;

FIG. 2 is a front elevation view of the device of FIG. 1 in an open position;

FIG. 3 is a rear elevation view of the device of FIG. 1 in an open position;

FIG. 4 is a right side elevation view of the device of FIG. 1 in an open position;

FIG. 5 is a left side elevation view of the device of FIG. 1 in an open position;

FIG. 6 is a left side elevation view of the device in FIG. 1 in a closed position;

FIG. 7 is a cross-sectional view of the device taken along the line of 7-7 of FIG. 4; and

FIG. 8 is a cross-sectional view of the device taken along the line of 8-8 of FIG. 6.

### DETAILED DESCRIPTION

The following detailed description is of the best currently contemplated modes of carrying out the invention. The description is not to be taken in a limiting sense, but is made merely for the purpose of illustrating the general principled of the invention, since the scope of the invention is best defined by the appended claims.

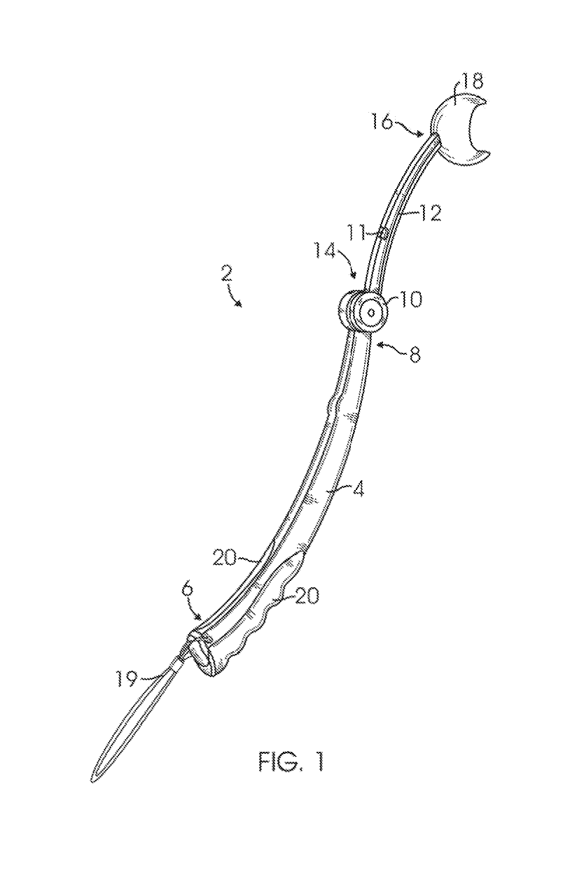

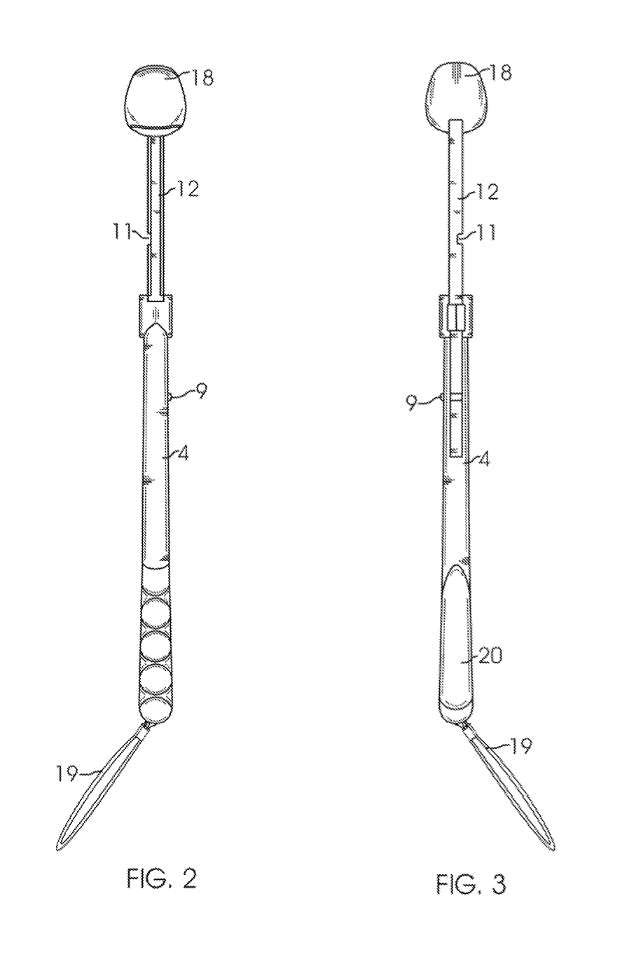

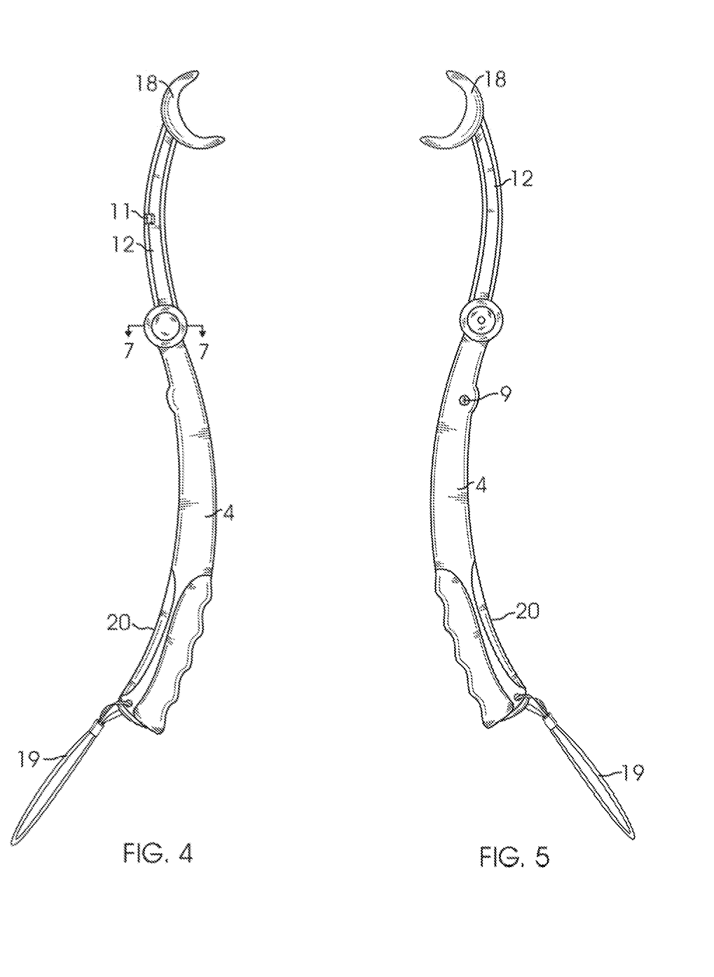

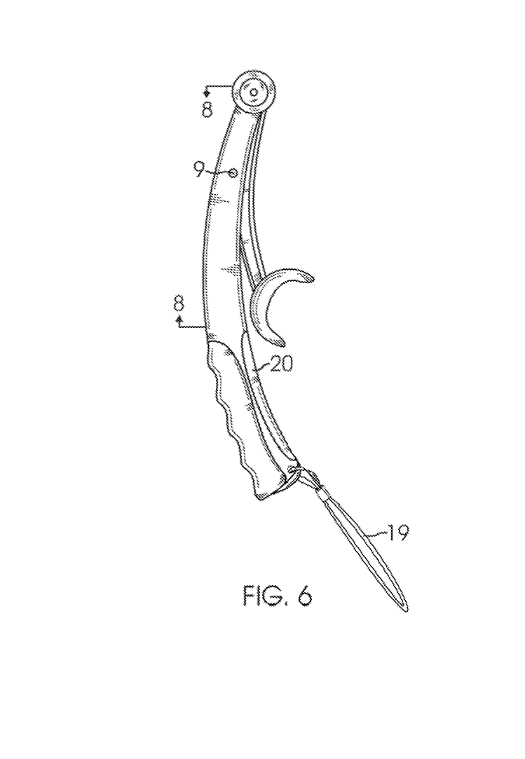

FIGS. 1-5 illustrate various views of a device 2 for throwing an object. Device 2, shown in an extended position, includes a body portion 4, a pivot mechanism 10, a swingable arm 12, and a object holder 18.

In one embodiment, body portion 4 of device 2, includes a first end 6, which functions as a gripping area or handle, and a second end 8, which is connected to pivot mechanism 10. In one embodiment, first end 6 of body portion 4 may be coated with a grip 20 for easy gripping by a user. Grip 20 may be a non-slip, rubber grip, with a performed area made to accommodate a human hand. Although grip 20 is shown on a front and back side of the body 4, those of skill in the art will understand that grip 20 may be applied on either the front or back side (or both the front and back side) of body portion 4 alone.

In one embodiment, first end 6 of body portion 4 may include a strap 19 for placement around the wrist of a user preventing the user from losing device 3 if the user's hand slips off device 2. Strap 19 may be made from rope, vinyl, fabric, plastic, or any other material known in the art. In one embodiment, strap 19 may include a slidable member for cinching strap 19 around the wrist of a user.

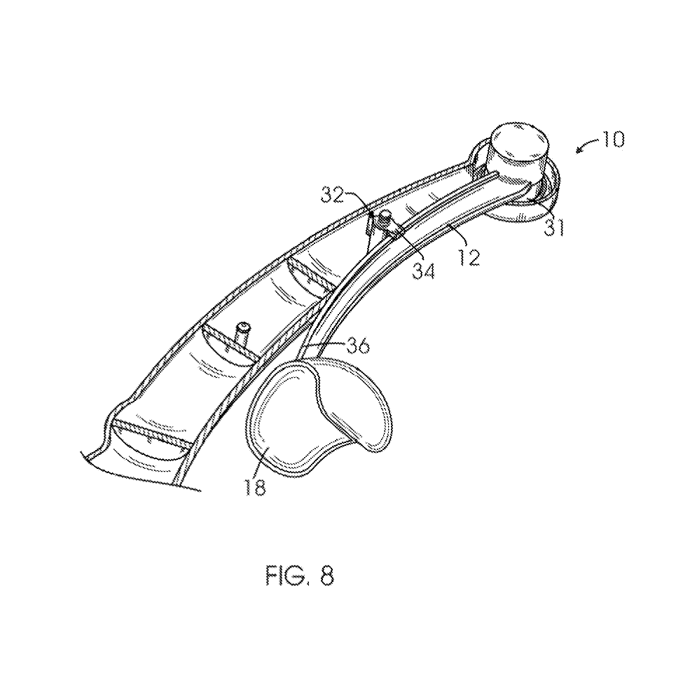

In one embodiment, swingable arm 12 of device 2 includes a first end 14 connected to pivot mechanism 10 and a second end 16 attached to object holder 18. Swingable arm 12 is rotatable between a first or stored position as shown in FIG. 6 and a second or extended position as shown in FIG. 1. As described in more detail below, a retaining element 34 (FIG. 8), which is detachably secured to a notch 11 in swingable arm 12, is actuated by a release button 9 located on body portion 4, provides a means for holding swingable arm in the first position and releasing swingable arm 12 to allow swingable arm 12 to move to the second position.

In one embodiment, object holder 18 may be used for holding an object to be thrown, such as a ball, rubber toy and the like. In one embodiment, object holder 18 is formed into a cup shape, which is closed at its lower end and open at its upper end, to allow a ball or similar object to be placed and held therein. It should be understood that, in some embodiments, object holder 18 may be designed, such that it may be used to grasp and hold objects to be thrown other than a ball.

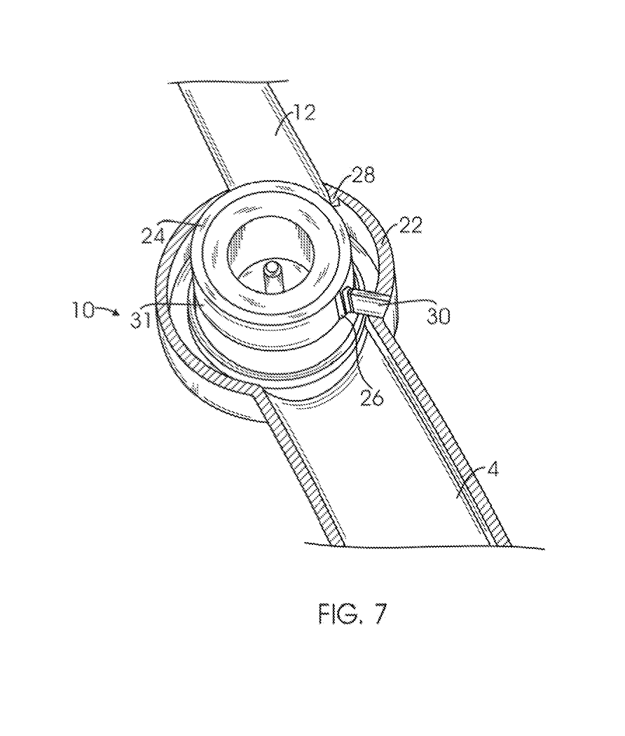

As understood from FIG. 7, showing the internal structure of pivot mechanism 10, pivot mechanism 10 include pivot joint housing 22 enclosing a concentrically positioned rotatable base unit 24, which is attached to swingable arm 12. First and second rotatable base units 24, 31 are rotatably engaged with pivot joint housing 22 and capable of rotating swingable arm 12 relative to pivot joint housing 22.

In one embodiment, rotatable base unit 24 includes an outwardly extending protrusion 26, while pivot joint housing 22 includes protrusions 28 and 30, which serve as a first rotational stop 28 and a second rotational stop 30. In operation, as rotatable base unit 24 is allowed to rotate to move swingable arm 12, for example, between the first position and the second position, protrusion 26 rotated as well. When protrusion 26 reaches the first position, protrusion 26 contacts first rotational stop 28 to prevent further rotation of swingable arm 12 past the first position. Similarly, when base unit 24 is allowed to rotate to move swingable arm 12 to the second position, protrusion 26 rotates past second rotational stop 30 locking swingable arm 12 into the second position and prevents rotation of swingable arm 12 past the second position. The positioning of first and second rotational stops 28 and 30 relative to each other may be varied so as to vary the amount of travel allowed for swingable arm 12 between the first and second positions.

In one embodiment, a second rotatable base unit 31 is attached on an upper end of rotatable base unit 24. Second rotatable base unit 31 includes outwardly extending protrusion 26 and rotates in unison with first rotatable base unit 24. As described above, when protrusion 26 reaches the first position, protrusion 26 contacts first rotational stop 28 to prevent further rotation of swingable arm 12 past the first position. Similarly, when base unit 24, along with second rotatable base unit 31, are allowed to rotate to move swingable arm 12 to the second position, protrusion 26 rotates past second rotational stop 30 locking swingable arm 12 into the second position and prevents rotation of swingable arm 12 past the second position.

FIG. 8 is a cross-sectional view of body portion 4 device 2 taken along the line of 8-8 of FIG. 6 showing a locking device 32 for retaining device 2 in the first or stored (or closed) position. In one embodiment, locking device 32 includes an L-shaped retaining element 34, which includes a hooking element or latch that engages notch 11 in an outwardly projecting ridge 36 formed on a corresponding edge of swingable arm 12. Operationally, when the hooking element engages ridge 36, swingable arm 12 is held firmly against body portion 4. To release swingable arm 12 from the first position, the user depresses release button 9 (FIG. 1), which causes retaining element 34 to disengage from notch 11 on ridge 36, allowing swingable arm 12 to move to the second or extended position. Swingable arm 12 held in the second or stored position provides for a compact arrangement of device 2 for convenient storage and transportation.

In an exemplary operational embodiment, to use device 2 of the present invention, an object to be thrown, such as a ball, is inserted into object holder 18 while swingable arm 12 is in the first or stored position. Once the object to be thrown is inserted, the user can release swingable arm 12, such as by depressing release button 9, to disengage swingable arm 12 from the stored position. The user may then firmly grip body portion 4, at first end 6, and using an overhead casting type motion, swing device 2 forward until swingable arm 12 reaches the second or fully extended position (FIG. 1). The casting motion coupled with the movement of swingable arm 12 slings the object to be thrown out from object holder 18.

In one embodiment, as swingable arm 12 reaches the second position by rotating past protrusion 26, swingable arm 12, locks into the extended position. Having device 2 locked into the second position facilitates subsequent pick up of the thrown object. In one embodiment, to pick up the object, the user firmly presses object holder 18 down on the object until swingable arm 12 unhinges. This process can be repeated.

One or more of the components and functions illustrated in FIGS. 1, 2, 3, 4, 5, 6, 7 and/or 8 may be rearranged and/or combined into a single component or embodies in several components without departing from the invention.

While the present invention is described above with respect to certain embodiments, it is to be understood that the invention is not limited to that described above. To the contrary, the invention is intended to cover various modification and equivalent arrangements within the spirit and scope of the appended claims.

What is claimed is:

1. A device for throwing an object comprising:
a body including a first and second end, the second end connected to a pivot mechanism; and
a swingable arm rotatable between a first position and a second position, the swingable arm having a first end connected to the pivot mechanism and a second end connected to an object holder, the pivot mechanism including:
a pivot housing including at least one outwardly extending protrusion; and
a base unit rotatably engaged with the pivot housing and capable of rotating the swingable are relative to the base unit.

2. The device of claim 1, further comprising a first rotational stop and a second rotational stop fixedly attached to the pivot housing.

3. The device of claim 2, wherein the swingable arm is in the first position when the protrusion contacts the first rotational stop.

4. The device of claim 3, wherein the swingable arm is in the second position when the protrusion is past the second rotational stop.

5. The device of claim 1, wherein the body comprises non-slip, rubber grip.

6. The device of claim 1, wherein the swingable arm comprises an outwardly projecting ridge extending along an outer edge of the swingable arm.

7. The device of claim 6, further comprising a locking mechanism, the locking mechanism securing the swingable arm is a fixed position relative to the body.

8. The device of claim 1, wherein the first position comprises the swingable arm in a stored position.

9. The device of claim 1, wherein the second position comprises the swingable arm in an extended position,

10. A device for throwing an object comprising:
a body including a first and second end;
a swingable arm, having a first end and a second end, rotatable between a first position and a second position; and
a pivot mechanism coupled to the body and the swingable arm, the pivot mechanism including:
a pivot housing; and
a base unit including at least on outwardly extending protrusion rotatably engaged with the pivot housing and coupled to the swingable arm, rotation of the base unit causing the swingable arm to rotate between the first and second position.

11. The device of claim 10, further comprising a first rotational stop and a second rotational stop fixedly attached to the pivot housing.

12. The device of claim 11, wherein the swingable arm is in the first position when the protrusion abuts the first rotational stop.

13. The device of claim 12, wherein the swingable arm is in the second position when the protrusion abuts the second rotational stop.

14. The device of claim 10, wherein the body comprises a non-slip rubber grip.

15. The device of claim 10, wherein the swingable arm comprises an outwardly projecting ridge extending along an outer edge of the swingable arm.

16. The device of claim 10, further comprising a locking mechanism, the locking mechanism securing the swingable arm in a fixed position relative to the body.

17. The device of claim 10, wherein the first position comprises the swingable arm in a stored position.

18. The device of claim 10, wherein the second position comprises the swingable arm in an extended position.

19. A device for throwing an object comprising:
a body including a first and second end, the body having a non-slip rubber grip;
a swingable arm, having a first end and a second end, rotatable between a first position and a second position; and
a pivot mechanism coupled to the body and the swingable arm, the pivot mechanism including:
a pivot housing including a first rotational stop and a second rotational stop fixedly attached to the pivot housing, and
a base unit including at least one outwardly extending protrusion rotatably engaged with the pivot housing and coupled to the swingable arm, rotation of the base unit causing the swingable arm to rotate between the first and second position; and
a locking mechanism securing the swingable arm in a fixed position relative to the body.

20. The device of claim 19, wherein the first position comprises the at least one outwardly extending protrusion contacting the first rotational stop; and wherein the second position comprises the at least one outwardly extending protrusion contacting the second rotational stop.
